(19) United States
(12) Patent Application Publication
(10) Pub. No.: US 2026/0316253 A1
(43) Pub. Date: Oct. 15, 2026

(54) STAND FOR SUPPORTING A BICYCLE IN A RAISED POSITION

(71) Applicant: GIANT SPACE LIMITED, Newport Gwent (GB)

(72) Inventor: Tony Ray, Newport Gwent (GB)

(73) Assignee: GIANT SPACE LIMITED, Newport Gwent (GB)

(21) Appl. No.: 19/481,267

(22) PCT Filed: Apr. 25, 2024
(86) PCT No.: PCT/GB2024/051079

§ 371 Date: Nov. 4, 2025

(30) Foreign Application Priority Data
May 5, 2023 (GB) 2306705.1

(51) Int. Cl. B25H 1/00; B25H 1/08; B25H 1/10

(52) U.S. Cl. CPC B25H 1/0014; B25H 1/0042; B25H 1/08; B25H 1/10

(57) ABSTRACT

The present invention relates to a stand for a bicycle that enables raising of the bike to an elevated position thereby allowing maintenance or inspection. there is a support stand for assisted lifting of a bicycle to an elevated position, the support stand comprising:
a support structure;
a clamp arrangement for clamping onto a bike, the clamp arrangement being mounted to a carriage, the carriage being moveable along the support structure for enabling height adjustment of the clamp arrangement between a lowered and an elevated position;
a biasing arrangement secured to the carriage for biasing the carriage toward the elevated position from the lowered position; and
a user actuable securing arrangement moveable between an engaged and a disengaged configuration, where in an engaged configuration the securing arrangement is arranged to engage with the support structure and carriage and maintain the carriage at an elevated position.

The present invention relates to a stand for a bicycle that enables raising of the bike to an elevated position thereby allowing maintenance or inspection.

A typical stand for supporting a bicycle to allow display or maintenance has a support structure comprising a telescopic main spar having a clamp arrangement at a distal end. The main spar is raised and fixed in position at the height appropriate for the user to work on a bike before the bike is loaded into the clamping arrangement. This is because the telescopic main spar cannot easily extend once the bike is loaded, because the weight of the bike prevents the telescopic action. The weight of the bike ‘hangs’ off the front of the stand, creating a turning moment on the vertical extension of the telescopic spar, introducing friction main spar and the support structure beneath.

The user therefore sets the height, then physically lifts the bike into place, clamping the stand's jaws around one of the bike's tubes. For this reason, most stands have ‘quick release’ clamps, or ratchet mechanisms, so that the jaws can be closed as quickly as possible as a result of both user's hands being in use to lift the bike. The user then has to balance the bike with only one hand while the clamp is tightened.

For some individuals this is acceptable, however many users struggle with the weight of the bicycle. This becomes difficult for the majority of users when lifting an electrically assisted bicycle. Electrically assisted bicycles typically have a mass of upwards of 20 kg, meaning lifting them off the ground is sufficiently difficult without attempting to locate into a clamping arrangement which may be at a significantly raised height.

Aspects of the present invention aim to address the above-mentioned deficiencies or at least provide a useful alternative.

According to the present invention there is a support stand for assisted lifting of a bicycle to an elevated position, the support stand comprising:
a support structure;
a clamp arrangement for clamping onto a bike, the clamp arrangement being mounted to a carriage, the carriage being moveable along the support structure for enabling height adjustment of the clamp arrangement between a lowered and an elevated position;
a biasing arrangement secured to the carriage for biasing the carriage toward the elevated position from the lowered position; and
a user actuable securing arrangement moveable between an engaged and a disengaged configuration, where in an engaged configuration the securing arrangement is arranged to engage with the support structure and carriage and maintain the carriage at an elevated position.

The support stand is beneficially a bicycle work stand. The carriage preferably extends outwardly from the support structure.

The support stand is beneficially arranged to assist manual lifting of a bicycle to a elevated position for example to enable maintenance or display. The biasing arrangement is beneficially arranged to exert a force of between 50 N and 200 N on the carriage, even more preferably in the range of 60 N-150 N. A suitable biasing arrangement may exert a force of 110 N on the carrier. The biasing arrangement beneficially exerts an upward force that is less than the downward force (weight) of the bicycle to be lifted. For example, an electric bicycle typically has a mass of 20 kg and weight of 200 N. The biasing arrangement will therefor partially assist lifting of the bicycle with an individual providing the remaining upward lift. It will be appreciated that the biasing arrangement biases the carriage to the elevated configuration.

The securing arrangement preferably comprises a mechanical fixing carried by the carriage. The securing arrangement is preferably moveable in an axis perpendicular to a longitudinal axis of the support element. A biasing element is beneficially provided for biasing the securing arrangement to the engaged configuration, where the biasing arrangement may comprise a spring. The securing arrangement preferably comprises a securing pin.

The support structure preferably comprises a plurality of longitudinally spaced engagement formations for selective receipt of the securing arrangement. It is beneficial that the carriage is height adjustable enabling an individual to secure the bicycle at a desired height. It is further beneficial that there is at least one engagement formation for enabling the carriage to be locked in the lowered position to allow an individual to secure the bicycle with the clamping arrangement without simultaneously having to maintain a downward force on the biasing arrangement.

The biasing arrangement preferably comprises a first end secured to the support structure and a second end secured to the carriage. The biasing arrangement preferably bears against the carriage for pushing the carriage upwardly. The biasing arrangement preferably extends parallel to the longitudinal length of the support stand.

The support stand preferably comprises one or more bearings intermediate the carriage and the support structure for enabling relative movement between the carriage and the support structure.

The one or more bearings preferable comprise first and second bearings intermediate the carriage and the support structure for cooperating with first and second bearing surfaces respectively, where the first and second bearing surfaces are disposed in different planes. The first bearing beneficially bears against the first bearing surface such that a force is exerted in a first direction, and the second bearing beneficially bears against the second bearing surface such that the force is exerted in a second opposing direction. The first and second bearing surfaces are beneficially elongate and linear. The first and second bearing surfaces are beneficially disposed in parallel planes.

There preferably further comprise third and fourth bearings intermediate the carriage and the support structure for cooperating with the third and fourth bearing surfaces respectively, where the third and further bearing surfaces are disposed in different planes.

The first and second bearing surfaces are beneficially parallel to one another, and the third and fourth bearing surfaces are parallel to one another, and wherein the first and second bearing surfaces are perpendicular to the third and fourth bearing surfaces.

It is preferable that the one or more bearings are mounted to the carrier. The support structure preferably defines the first and second bearing surfaces.

The provision of bearings brace the carriage with respect to the support structure and prevent movement other than in a vertical axis. This means that the weight of the bicycle cannot pull the carriage from the vertical axis even though the weight of the bicycle hanging from the clamp attempts to do so. This is a significant limitation associated with telescopic arrangements. The braced carriage transfers this ‘turning’ force to the support structure itself, converting the lateral force into a vertical force meaning lifting the bicycle is significantly easier.

The support structure preferably defines a channel for receipt of the carriage. The carriage is preferably retained in the channel.

There is often a need to rotate the bicycle to various angle relative to the ground to enable maintenance to be performed on specific aspects of the bicycle, for example when bleeding hydraulic brakes. The weight of electrically assisted bicycles particularly exerts significant forces onto any mechanism that allows rotation. Accordingly, there is a risk that a mechanism can be overtightened, or alternatively that a mechanism slips, and the bicycle rotates back to a resting position. Accordingly, the clamp arrangement is beneficially rotationally mounted and configured to rotate relative to the carriage, and wherein the carriage further comprises a locking mechanism for locking the clamping arrangement in one of a plurality of orientations relative to the carriage. The clamp arrangement preferably comprises a plurality of teeth (beneficially defined by a plurality of longitudinally extending peaks and troughs) and the locking mechanism beneficially comprises one or more locking teeth for intermeshing between the teeth of the clamp arrangement, the locking mechanism being moveable between an engaged configuration where the one or more locking teeth are intermeshed between the teeth of the clamp arrangement and a disengaged configuration where the one or more locking teeth are disengaged from between the teeth of the clamping arrangement. The locking mechanism may be termed a clutch.

Such a mechanism enabling relative rotation between the clamping arrangement and the carriage provides several significant advantages. With the locking mechanism teeth engaged with the clamping arrangement teeth resistance to movement is absolute and no tightening is required. Instead, it is simply effectively an in/out switch to engage the clutch where the locking mechanism is no under stress when ready to be engaged. Instead, the bike is rotated to the desired angle, and the locking mechanism activated whereby the teether intermesh.

The clamp arrangement preferably extends lengthwise away from the carriage and comprises a longitudinal axis about which axis the clamping arrangement is arranged to rotate, and where the clamp arrangement teeth extend longitudinally. The locking mechanism is beneficially rotatable about a locking mechanism rotation axis between the engaged and disengaged configuration. The locking mechanism rotation axis and longitudinal axis about which the clamping arrangement rotates are preferably perpendicular to one another.

The clamp arrangement comprises a first and second jaw moveable relative to one another and a mechanism for drawing the first jaw towards the second jaw.

The support structure preferably comprises a base and a support element extending upwardly from the base. It will be appreciated that in an alternative configuration the support structure may be mounted directly to a wall or other structure for example.

According to a second aspect of the present invention there is a support stand for assisted lifting of a bicycle to an elevated position, the support stand comprising:
a support structure;
a clamp arrangement for clamping onto a bike, the clamp arrangement being mounted to a carriage, the carriage being moveable along the support structure for enabling height adjustment of the clamp arrangement between a lowered and an elevated position, the support stand comprising one or more bearings intermediate the carriage and the support structure for enabling relative movement between the carriage and the support structure.

The support stand preferably further comprises a user actuable securing arrangement moveable between an engaged and a disengaged configuration, where in an engaged configuration the securing arrangement is arranged to engage with the support structure and carriage and maintain the carriage at an elevated position.

The support stand preferably further comprises a biasing arrangement secured to the carriage for biasing the carriage toward the elevated position from the lowered position.

It will be appreciated that preferred features of the first aspect of the invention are equally preferred features of the second aspect of the invention.

According to a third aspect of the present invention there is a support stand for assisted lifting of a bicycle to an elevated position, the support stand comprising:
a support structure;
a clamp arrangement for clamping onto a bike, the clamp arrangement being mounted to a carriage, the carriage being moveable along the support structure for enabling height adjustment of the clamp arrangement between a lowered and an elevated position and wherein the clamp arrangement is configured to rotate relative to the carriage, and wherein the carriage further comprises a locking mechanism for locking the clamping arrangement in one of a plurality of orientations relative to the carriage, where the clamp arrangement comprises a plurality of teeth and the locking mechanism comprises one or more locking teeth for intermeshing between the teeth of the clamp arrangement, the locking mechanism moveable between an engaged configuration where the one or more locking teeth are intermeshed between the teeth of the clamp arrangement and a disengaged configuration where the one or more locking teeth are disengaged from between the teeth of the clamping arrangement.

The support stand preferably further comprises a user actuable securing arrangement moveable between an engaged and a disengaged configuration, where in an engaged configuration the securing arrangement is arranged to engage with the support structure and carriage and maintain the carriage at an elevated position.

The support stand preferably further comprises a biasing arrangement secured to the carriage for biasing the carriage toward the elevated position from the lowered position.

It will be appreciated that preferred features of the first aspect of the invention are equally preferred features of the third aspect of the invention.

Aspects of the present invention will now be described by way of example only with reference to the accompanying drawings where:

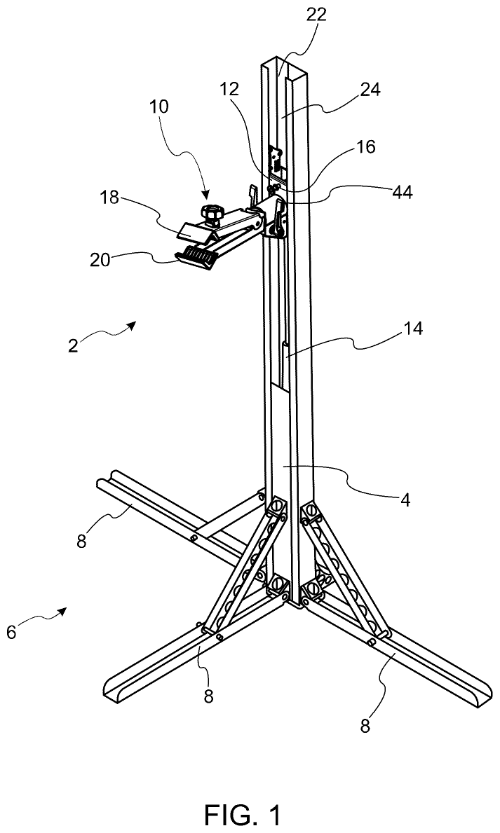

FIG. 1 is a schematic perspective view of an illustrative embodiment of the present invention.

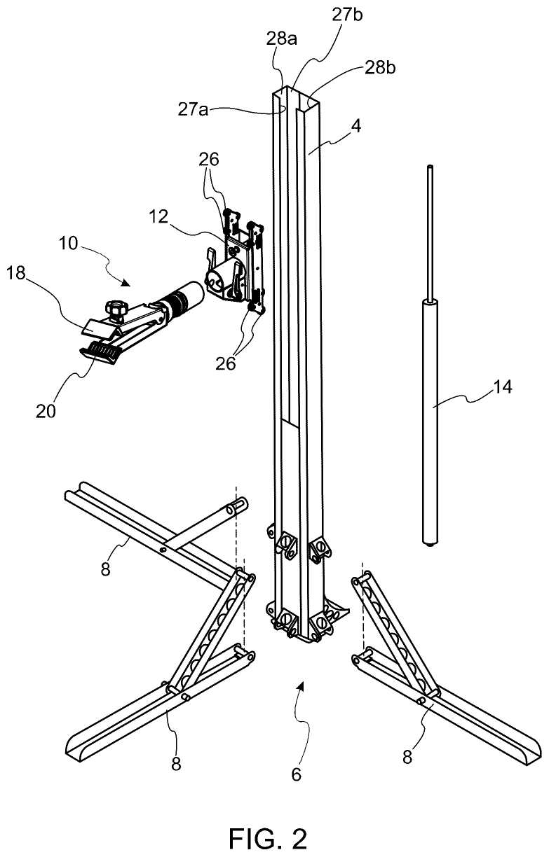

FIG. 2 is a schematic exploded view of an illustrative embodiment of the present invention.

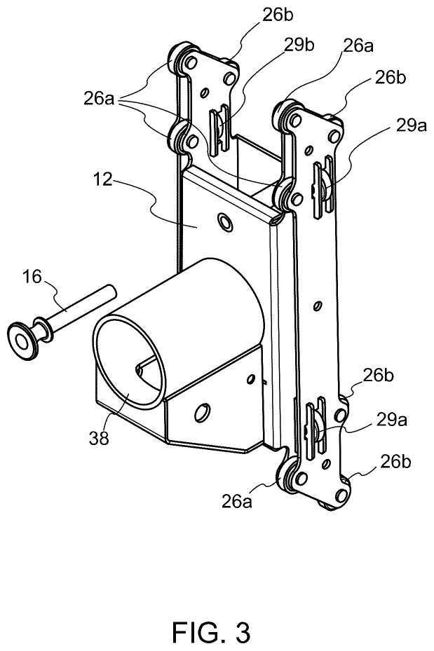

FIG. 3 is a schematic perspective view of a carriage forming part of an illustrative embodiment of the present invention.

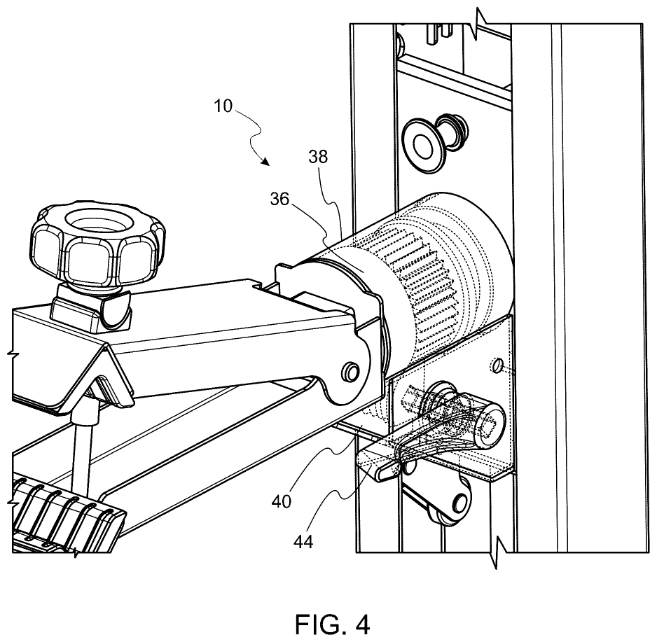

FIG. 4 is a schematic perspective view of part of an illustrative embodiment of the present invention.

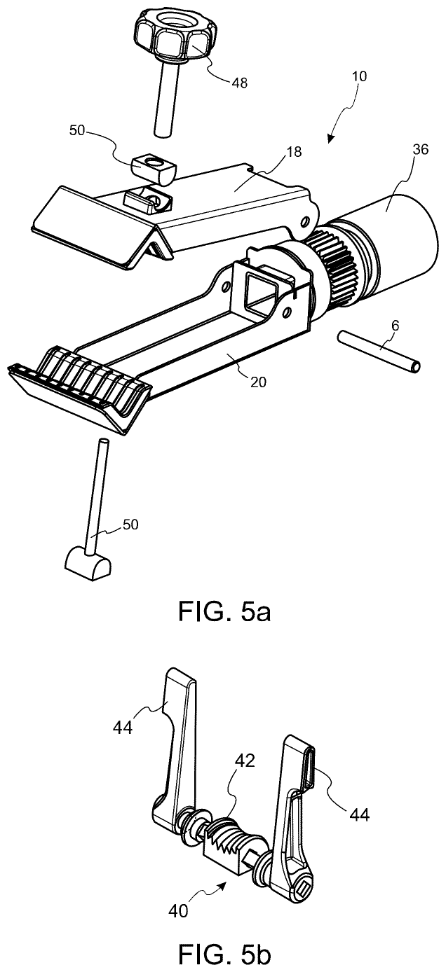

FIG. 5 is a schematic exploded view of a clamp arrangement forming part of an illustrative embodiment of the present invention, and FIG. 5b is a perspective view of a clutch forming part of an illustrative embodiment of the present invention.

Referring to FIGS. 1 and 2 an illustrative embodiment of the present invention is represented where there is a support stand 2 comprising a support structure 4 extending upwardly from a base 6. The base 6 comprise a plurality of legs 8 extending outwardly from the support structure 4 where the legs 8 are pivotable relative to the support structure 4 from a deployed configuration as shown in FIGS. 1 and 2 to a collapsed configuration where the legs are aligned longitudinally with the longitudinal length of the support structure thereby enabling ese of transportation and storage.

The stand further comprises a clamp arrangement 10 for clamping onto a bike, the clamp arrangement being mounted to a carriage 12 which in turn is moveable along the support structure 4 for enabling height adjustment of the clamp arrangement 10 between a lowered and an elevated position. A biasing arrangement 14 is secured to the carriage 12 for biasing the carriage 12 toward the elevated position from the lowered position. A user actuable securing arrangement 16 is provided which is carried by the carriage 12 and is moveable relative to the support structure 4 between an engaged and a disengaged configuration. In the engaged configuration the securing arrangement 16 (which may comprise a pin) is arranged to engage with the support structure 4 maintain the carriage 12 at an elevated position.

In one embodiment the biasing arrangement comprises a gas strut which is arranged such that the carriage 12 is biased to an extended configuration. The force that the biasing arrangement is capable of exerting can be selected by selecting a suitable biasing arrangement 14, and in some embodiments an adjustable biasing arrangement 14 may be provided where the upward force can be adjusted dependent upon the weight of the bike. It is beneficial however that the force exerted on the carriage 12 by the biasing arrangement is less than the weight of the bike, preferably less than half of the weight of the bike. An advantage of this is that the carriage 12 can be lowered with relative ease by the user when the bike is not held by the clamping arrangement.

The clamp arrangement 10 comprises a first and second jaw 18,20 moveable relative to one another and a mechanism for drawing the first jaw 18 towards the second jaw 20.

In the illustrative embodiment the support structure 4 defines a channel 22 for receipt of the carriage 12, where the carriage is retained in the channel 22. It will be appreciated that in an alternative embodiment the carriage 12 may however encapsulate a portion of the support structure 4 and thereby sit outside the support structure 4.

In the illustrative embodiment the support structure 4 comprises a box section having a slot 24 through which the carriage 12 projects. The box section comprises multiple bearing surfaces against which carriage bearings 26 communicate to enable relative movement between the carriage and the support structure. The carriage bearings 26,29 are best shown in FIG. 3 where the carriage 12 is shown in more detail. The carriage 12 comprises first and second bearings 26a, 26b facing opposing directions for engagement with first and second elongate bearings surfaces 27a, 27b that extend longitudinally parallel to the longitudinal height of the support structure 4 as shown in FIG. 2. It will be appreciated that the first and second bearing surfaces 27a, 27b are disposed in different planes. The first bearing 26a bears against the first bearing surface 27a such that a force is exerted in a first direction, and the second bearing 26b bears against the second bearing surface 27b such that the force is exerted in a second opposing direction. It will be appreciated that it is beneficial that the first bearing 26a is aligned with the axis in which the clamping arrangement projects from the carriage meaning that the there is direct support for the carriage 12 against the first bearing surface 27b.

It is beneficial that there is a plurality of first bearings 26a and second bearings 26b. In the illustrative embodiment there are six of each, where there are three spaced on opposing sides of the location at which the clamping arrangement projects from the carriage. This spreads the load of the bike supported by the clamping arrangement through the carriage 12.

While the first and second bearings and the corresponding bearing surfaces brace the carriage effectively, to accommodate side to side forces third and fourth bearings 29a, 29b are provided intermediate the carriage 12 and the support structure 4 for cooperating with third and fourth bearing surfaces 28a, 29b respectively, where the third and further bearing surfaces 28a, 28b are disposed in different planes. It will be appreciated that the first and second bearing surfaces 27a, 27b are parallel to one another, and the third and fourth bearing surfaces 28a, 28b are parallel to one another, and wherein the first and second bearing surfaces 27a, 27b are perpendicular to the third and fourth bearing surfaces 28a, 28b.

Referring to FIG. 3, the securing arrangement 16 is more clearly shown. The securing arrangement 16 comprises a pin 16 carried by the carriage. The pin projects through an aperture in the carriage and into corresponding receiving apertures in the side of the support arrangement 4 opposite the slot 22. The pin is retained in position and may be spring loaded to bias to a position in which the pin is engaged with an aperture in the securing arrangement. It is beneficial that there are multiple spaced apart apertures in the support arrangement for corresponding receipt of the pin in multiple locations enabling adjustment of the height for a user's comfort.

There is often a need to rotate the bicycle to various angles relative to the ground to enable maintenance to be performed on specific aspects of the bicycle, for example when bleeding hydraulic brakes. As best shown in FIGS. 4 and 5, the clamp arrangement 10 extends outwardly from the carriage 12 and rotates relative to the carriage 12. The clamp arrangement 10 comprises a plug portion 36 which is received into a corresponding socket 38 provided by the carriage 12 (as shown in FIG. 3) so that the plug portion 36 can rotate relative to the socket 38. The plug portion 36 is circumferentially splined with the teeth aligned in the axis of rotation thus providing a plurality of rotational locking positions for the plug portion 36 relative to the socket 38. Securing is achieved through the provision of a locking mechanism in the form of a clutch 40 as best shown in FIG. 5b. The clutch 40 comprises a plurality of locking teeth 42 for intermeshing between the teeth of the plug portion 36 and is moveable between an engaged configuration and a disengaged configuration through the action of a lever 44. Rotation of the lever 44 thereby fixes the plug portion 36 in a relative orientation as required.

With further reference to FIG. 5a the first and second jaws 18,20 are moveable relative to one another for securing the bike therebetween. A tightening arrangement 48,50 is arranged to draw the first jaw 18 towards the second jaw 20 by means of the first jaw 18 being pivotally mounted. An appropriate shaped spacer 50 accommodates the change in angle of the first jaw 18 relative to the second jaw 20.

In operation the clamping arrangement 10 is pushed downwardly to correspondingly move the carriage downwardly. The frame of a bike is then positioned between the first and second jaws 18,20 which are then closed through action of rotation of the tightening element 48. At this point the weight of the bike acts to hold the clamp arrangement and carriage in the lowered position. Action of the gas strut 14 can then assist the user in raising of the bike to the desired height. The pin 16 is then engaged with an aperture in the support structure 4 and the bike is thereby held in position. Release and subsequent re-engagement of the clutch 40 can then allow rotation of the bike to the desired angle to allow maintenance to be completed.

Aspects of the present invention have been described by way of example only and it will be appreciated to the skilled addressee that modifications may be made without departing from the scope of protection afforded by the appended claims.

1. A support stand for assisted lifting of a bicycle to an elevated position, the support stand comprising:
a support structure;
a clamp arrangement for clamping onto a bike, the clamp arrangement being mounted to a carriage, the carriage being moveable along the support structure for enabling height adjustment of the clamp arrangement between a lowered position and an elevated position;
a biasing arrangement secured to the carriage for biasing the carriage toward the elevated position from the lowered position; and
a user actuable securing arrangement moveable between an engaged and a disengaged configuration, where in an engaged configuration the securing arrangement is arranged to engage with the support structure and carriage and maintain the carriage at the elevated position.

2. The support stand according to claim 1, wherein the biasing arrangement biases the carriage to the elevated position.

3. The support stand according to claim 1, wherein the securing arrangement comprises a mechanical fixing carried by the carriage.

4. The support stand according to claim 3, wherein the securing arrangement is moveable in an axis perpendicular to a longitudinal axis of a support element of the support structure.

5. The support stand according to claim 3, further comprising a biasing element for biasing the securing arrangement to the engaged configuration.

6. A The support stand according to claim 3, wherein the securing arrangement comprises a securing pin.

7. The support stand according to claim 1, wherein the support structure comprises a plurality of longitudinally spaced engagement formations for selective receipt of the securing arrangement.

8. The support stand according to claim 1, wherein the biasing arrangement comprises a first end secured to the support structure and a second end secured to the carriage.

9. A The support stand according to claim 1, wherein the support stand comprises one or more bearings intermediate the carriage and the support structure for enabling relative movement between the carriage and the support structure.

10. The support stand according to claim 9, wherein the one or more bearings comprises first and second bearings intermediate the carriage and the support structure for cooperating with first and second bearing surfaces respectively, where the first and second bearing surfaces are disposed in different planes.

11. The support stand according to claim 10, wherein the first and second bearing surfaces are disposed in parallel planes.

12. The support stand according to claim 10, further comprising a third bearing having a third bearing surface and a fourth bearing having a fourth bearing surface, the third bearing and the fourth bearing intermediate the carriage and the support structure for cooperating with the third and fourth bearing surfaces respectively, where the third and fourth bearing surfaces are disposed in different planes.

13. The support stand according to claim 12, wherein the first and second bearing surfaces are parallel to one another, and the third and fourth bearing surfaces are parallel to one another, and wherein the first and second bearing surfaces are perpendicular to the third and fourth bearing surfaces.

14. The support stand according to claim 9, wherein the one or more bearings are mounted to the carriage.

15. The support stand according to claim 10, wherein the support structure defines the first and second bearing surfaces.

16. The support stand according to claim 1, wherein the support structure defines a channel for receipt of the carriage.

17. The support stand according to claim 1, wherein the clamp arrangement is rotationally mounted relative to the carriage, and wherein the carriage further comprises a locking mechanism for locking the clamping arrangement in one of a plurality of orientations relative to the carriage.

18. The support stand according to claim 17, wherein the clamp arrangement comprises a plurality of teeth and the locking mechanism comprises one or more locking teeth for intermeshing between the teeth of the clamp arrangement, the locking mechanism moveable between an engaged configuration where the one or more locking teeth are intermeshed between the teeth of the clamp arrangement and a disengaged configuration where the one or more locking teeth are disengaged from between the teeth of the clamping arrangement.

19. The support stand according to claim 18, wherein the clamp arrangement extends lengthwise away from the carriage and comprises a longitudinal axis about which axis the clamping arrangement is arranged to rotate, and where the teeth of the claim arrangement extend longitudinally.

20. The support stand according to claim 19, wherein the locking mechanism is rotatable about a locking mechanism rotation axis between the engaged configuration and the disengaged configuration.

21. The support stand according to claim 20, wherein the locking mechanism rotation axis and the longitudinal axis about which the clamping arrangement rotates are perpendicular to one another.

22. The support stand according to claim 1, where the clamp arrangement comprises a first jaw and a second jaw moveable relative to one another and a mechanism for drawing the first jaw towards the second jaw.

23. The support stand according to claim 1, wherein the support structure comprises a base and a support element extending upwardly from the base.

24. The support stand according to claim 1, wherein the biasing arrangement is arranged to exert a force of between 50 and 200 N on the carriage.
